(19) United States
(12) Patent Application Publication
(10) Pub. No.: US 2023/0065440 A1
(43) Pub. Date: Mar. 2, 2023

(54) METHOD AND APPARATUS FOR MANAGING APPLICATION

(71) Applicant: SAMSUNG SDS CO., LTD., seoul (KR)

(72) Inventors: Jae Chun OH, Seoul (KR); A Reum HAN, Seoul (KR); Sung Pyo LEE, Seoul (KR); Hye Mi SEO, Seoul (KR); Hye Jung JUNG, Seoul (KR); Go Eun LEE, Seoul (KR); Da In UM, Seoul (KR); Jung Jun LEE, Seoul (KR); Ah Ra KO, Seoul (KR); Joo Yong PARK, Seoul (KR); Hee Suk JEONG, Seoul (KR)

(21) Appl. No.: 17/869,240

(22) Filed: Jul. 20, 2022

(30) Foreign Application Priority Data
Aug. 24, 2021 (KR) 10-2021-0111558

(51) Int. Cl. G06F 8/61; G06F 9/451

(52) U.S. Cl. CPC G06F 8/61; G06F 9/451; G06F 8/62

(57) ABSTRACT

A method for managing an application executed in a user terminal according to an embodiment of this disclosure includes executing a launcher application on the user terminal, displaying a first application list within a first GUI of the launcher application, installing, in the user terminal, a first application selected by a user from applications included on the first application list, displaying a second application list within a second GUI of the launcher application and executing a second application selected by the user from applications included on the second application list.

### CROSS-REFERENCE TO RELATED APPLICATION AND CLAIM OF PRIORITY

This application claims priority from Korean Patent Application No. 10-2021-0111558 filed on Aug. 24, 2021 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a method and an apparatus for managing an application. More particularly, the present disclosure relates to a method and an apparatus for managing an application to facilitate a change, removal and installation of an application.

### 2. Description of the Related Art

Various applications such as Internet banking applications, game applications, office applications, access management applications, and document management applications are installed and used in a user terminal. Such applications may be executed in the user terminal by downloading a binary executable file or an installation file from a server and installing the same in the user terminal.

Meanwhile, the functions of applications may be changed from time to time. For example, a new function may be added to an application, and a code (e.g., patch code) that resolves a fatal error may be added to an application. In this case, the user terminal needs to download an update file including the new function or the code from the server and update the application.

However, the update file needs to be transmitted to each of the user terminals, which may not only consume server and network resources, but also cause user to feel uncomfortable. For example, when there are multiple user terminals that desire to receive an update file, the number of downloads of the update file increases in proportion to the number of user terminals, leading to consumption in resources of the network and the server. In addition, the user may feel uncomfortable about downloading the update file directly because the download needs to proceed while performing a server connection process.

In addition, when an application is installed in a computing device with a binary executable or an installation file, it takes some time to install the application. In addition, since a storage space required to install the application must be secured, it also takes time to delete another application from the computing device.

### SUMMARY

Technical aspects to be achieved through one embodiment by the present disclosure provide a method and an apparatus for managing an application that can easily execute an application via URL access without using a binary executable file and an installation file.

Technical aspects to be achieved through one embodiment by the present disclosure also provide a method and an apparatus for managing an application that can easily performing an operation of installing, changing or deleting an application.

Technical aspects to be achieved through one embodiment by the present disclosure also provide a method and an apparatus for managing an application that can execute an application while using a small amount of storage space of a user terminal.

Technical aspects to be achieved through one embodiment by the present disclosure also provide a method and an apparatus for managing an application that can make both a user feel more comfortable in using an application and can make a manager feel more comfortable in managing the application.

The technical aspects of the present disclosure are not restricted to those set forth herein, and other unmentioned technical aspects will be clearly understood by one of ordinary skill in the art to which the present disclosure pertains by referencing the detailed description of the present disclosure given below.

According to the present disclosure, a method for managing an application executed in a user terminal is provided. The method may include executing a launcher application on the user terminal, displaying a first application list within a first GUI of the launcher application, installing a first application selected by a user from applications included on the first application list in the user terminal, displaying a second application list within a second GUI of the launcher application and executing a second application selected by the user from applications included on the second application list. The installing of a first application in the user terminal may include identifying a URL corresponding to the first application instead of downloading a binary executable file or an installation file of the first application from a server, and the executing of a second application may include accessing the URL corresponding to the second application by the launcher application instead of executing the binary executable file of the second application on the user terminal. The URL corresponding to the second application may be previously stored in the user terminal.

In some embodiments, the installing of a first application in the user terminal may include adding the first application to the second application list.

In some embodiments, the installing of a first application in the user terminal may include registering a package name corresponding to the first application in an operating system (OS) of the user terminal.

In some embodiments, the executing of a second application may further include prior to displaying a document obtained from the URL on the user terminal, displaying a splash screen corresponding to the second application by the launcher application. The splash screen may be previously stored in the user terminal.

In some embodiments, a method for managing an application executed in a user terminal may further include detecting an executable instruction including an application package name on the user terminal, in response to detecting the executable instruction, executing the launcher application and executing a third application by the launcher application based on determining by the launcher application that the third application corresponding to the package name is included on the second application list.

In some embodiments, the executing the second application may further include accessing the URL corresponding to the second application by a first instance of the launcher application and after the executing of a second application, the method may further include

detecting an executable instruction for a third application included on the second application list on the user terminal, generating a new process for a second instance of the launcher application on the user terminal and executing the third application by the second instance of the launcher application on the user terminal.

According to the present disclosure, a method for managing an application executed in a user terminal is provided. The method may further include updating the URL corresponding to the second application by the server. The executing of a launcher application on the user terminal may include obtaining the updated URL corresponding to the second application from the server.

According to the present disclosure, a method for managing an application executed in a user terminal is provided. The method may further include obtaining an uninstallation instruction for a third application among the applications included on the second application list and in response to the uninstallation instruction, changing a display state of the third application on the second application list displayed in the second GUI instead of deleting the binary executable file of the third application from the user terminal.

According to the present disclosure, a computing device is provided. The computing device may include one or more processors, a memory configured to load a program executed by the processors and a storage having the program stored therein, the program may include instructions that cause the processor to perform operations may include executing a launcher application on a user terminal, displaying a first application list within a first GUI of the launcher application, installing a first application selected by a user from applications included on the first application list in the user terminal and displaying a second application list within a second GUI of the launcher application executing a second application selected by the user from applications included on the second application list, the installing of a first application in the user terminal may include an operation of identifying a URL corresponding to the first application instead of downloading a binary executable file or an installation file of the first application from a server, and the executing of a second application may include an operation of accessing the URL corresponding to the second application by the launcher application instead of executing the binary executable file of the second application on the user terminal. The URL corresponding to the second application may be previously stored in the user terminal.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a view illustrating a system for managing an application according to one embodiment of the present disclosure;

FIG. 2 is a signal flowchart of a method for managing an application according to another embodiment of the present disclosure;

FIG. 3 is a view illustrating a management interface;

FIG. 4 is a view illustrating a first application list displayed in a first GUI;

FIG. 5 is a view illustrating another example of a first application list displayed in a first GUI;

FIG. 6 is a view illustrating a second application list displayed in a second GUI;

FIG. 7 is a signal flowchart of a method for managing an application according to another embodiment of the present disclosure;

FIG. 8 is a flowchart of a method for managing an application according to another embodiment of the present disclosure;

FIG. 9 is a flowchart illustrating a step S300 in FIG. 8 in more detail;

FIG. 10 is a flowchart illustrating a step S500 in FIG. 8 in more detail;

FIGS. 11 and 12 are flowcharts of a method for managing an application according to another embodiment of the present disclosure; and

FIG. 13 is a view illustrating an exemplary hardware configuration for implementing a computing device according to various embodiments.

### DETAILED DESCRIPTION OF THE EMBODIMENTS

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, various embodiments of the present disclosure will be described with reference to the attached drawings:

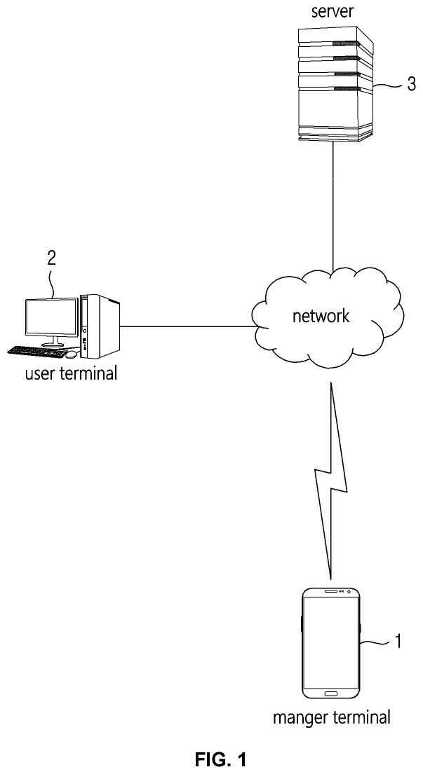

FIG. 1 is a view illustrating a system for managing an application according to one embodiment of the present disclosure.

Referring to FIG. 1, a system for managing application according to one embodiment of the present disclosure may include a user terminal 1, a manager terminal 2, and a server 3.

The server 3 may be a computing device that manages a launcher application. The server 3 may receive the launcher application from the manager terminal 2 and register the same in an app market. In addition, the server 3 may provide the launcher application to the user terminal 1. The launcher application may be a kind of management program for managing a plurality of applications.

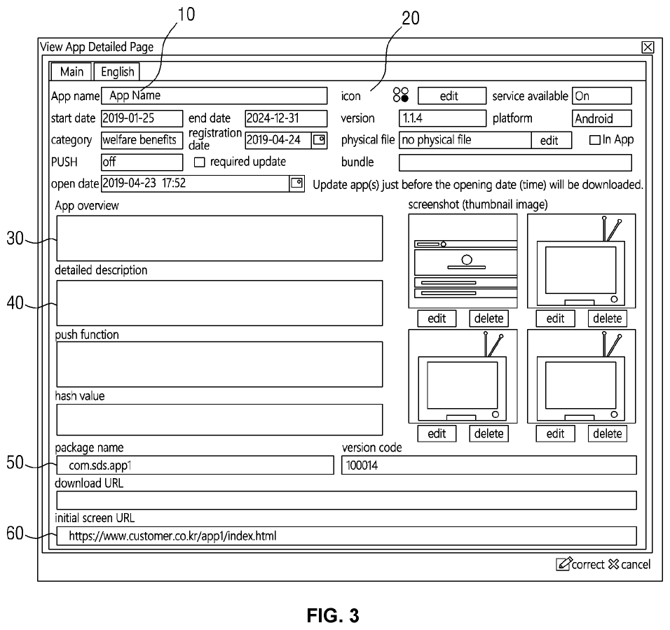

The manager terminal 2 is a device used by an application developer or an application manager, and may include computing devices such as a smartphone, a tablet PC, a laptop, and the like. The manager terminal 2 may register a launcher application including a plurality of application information using a management interface (see FIG. 3). In addition, the manager terminal 2 may change the information of the application using the management interface.

The launcher application is an application program capable of executing one or more applications and includes a plurality of application information. In addition, the launcher application may include a first GUI for displaying an application list and a second GUI for displaying an installed (executable) application list. Herein, the application information may include an application Uniform Resource Locator (URL), an icon of an application, a package name of an application, and a splash screen of an application. In one embodiment, when registering an application included in the launcher application, the manager terminal 2 may register application information including a URL of the application in the server 3 without registering a binary executable file or an installation file in the server 3. Herein, since the URL of the application is a URL set by the manager corresponding to the application, it may be a URL accessed when the application is executed. The URL may also be a home page address of another server.

The user terminal 1 may mount various applications therein, and may include mobile computing devices such as a smartphone, a tablet PC, and the like. According to some embodiments, the user terminal 1 may include computing devices such as a desktop PC, a laptop PC, and the like. The user terminal 1 may obtain the launcher application from the server 3 and select and install one or more applications from a plurality of applications included in the launcher application. In one embodiment, instead of downloading the binary executable file or the installation file of the application from the server 3, the user terminal 1 may receive information of the selected application from the server 3, identify the URL corresponding to the selected application using the information of the application, and manage the application as an installation application. In some embodiments, when installing the selected application, the user terminal 1 may identify an icon and a package name in the application information, may register the icon on a desktop or a home screen of the user terminal 1, and may register the package name in an operating system (OS) of the user terminal. In some embodiments, when the package name of the selected application is registered in the OS of the user terminal 1, the selected application may be registered on an installation application list managed by the OS. In addition, in some embodiments, the package name may be registered in the OS of the user terminal in association with the launcher application such that the launcher application is executed when an executable instruction including the package name of the selected application is detected in the OS of the user terminal 1.

The user terminal 1 may obtain a document (e.g., a web page) by executing one of the applications installed via the launcher application. In one embodiment, instead of executing the binary executable file of the application, the user terminal 1 may execute the application by identifying the URL of the executed application and accessing the identified URL to obtain a document.

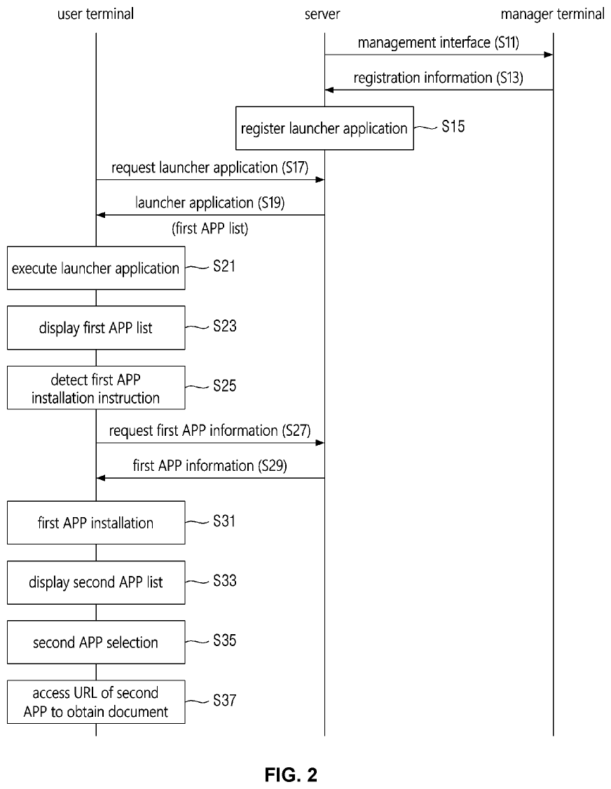

So far, the system for managing an application according to one embodiment of the present disclosure has been described with reference to FIG. 1. Hereinafter, a method for managing an application according to various embodiments of the present disclosure will be described with reference to FIGS. 2 to 12.

FIG. 2 is a signal flowchart of a method for managing an application according to another embodiment of the present disclosure.

Referring to FIG. 2, the manager terminal 2 may receive a management interface capable of registering one or more applications from the server 3 (S11). The one or more applications may be dependent upon the launcher application and may be managed by the launcher application.

FIG. 3 is a view illustrating a management interface, and the management interface may include a first input blank 10 capable of inputting an application name, a second input blank 20 capable of registering an icon, a third input blank 30 capable of recording an outline of an application, a fourth input blank 40 capable of recording a detailed description of the application, a fifth input blank 50 capable of inputting a package name, and a sixth input blank 60 capable of recording an application URL. The manager may register the plurality of applications by inputting information into each of the input blanks.

When the information has been input via the management interface, the manager terminal 2 may transmit registration information including one or more application information to the server 3 (S13). In one embodiment, the registration information may include the one or more application information. In addition, the registration information may include an icon of the launcher application, an application name, and an application programming interface (API) for executing the launcher application. In addition, the application information may include an application name, an outline of the application, detailed information, an icon, a package name, and a URL.

Furthermore, the server 3 may register the launcher application in the app market using the registration information (S15). Next, the user terminal 1 may access the server 3 and request download of the launcher application registered in the app market (S17), and the server 3 may transmit the launcher application to the user terminal 1 (S19). In one embodiment, the server 3 may transmit the API capable of executing the launcher application to the user terminal 1, and may further transmit the first application list to the user terminal 1. The plurality of applications managed via the launcher application may be recorded in the first application list.

Next, the user terminal 1 may execute the launcher application by calling the API received from the server 3 (S21). When the launcher application is executed in the user terminal 1, a first graphical user interface (GUI) in the launcher application may be output and a first application list may be displayed in the first GUI (S23). The first application list may be a full list of apps that may be executed or installed in the launcher application. In addition, state information of each of the applications may be displayed on the first application list on the first GUI. Herein, the state information of the application may display an installed state or an uninstalled state.

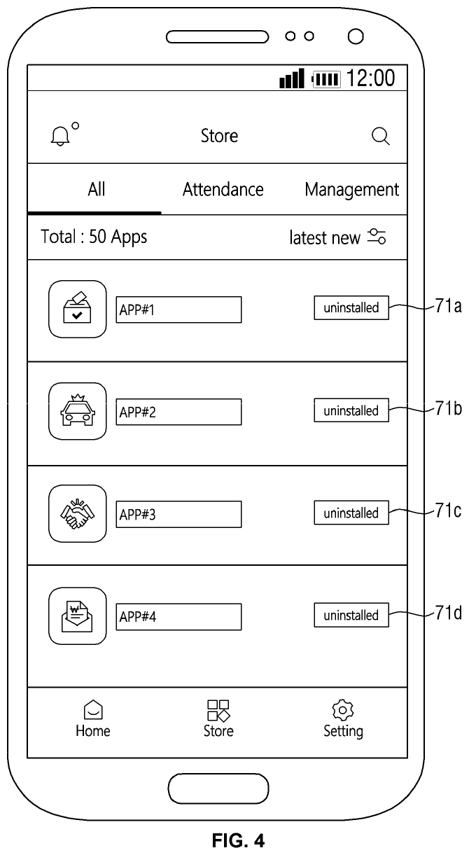

FIG. 4 is a view illustrating a first application list displayed in a first GUI.

As illustrated in FIG. 4, the plurality of applications that may be managed by the launcher application are displayed on the first GUI, and the state information 71a to 71d of each of the applications may be displayed as “uninstalled”. Immediately after the launcher application is downloaded, since not all applications on the first application list are installed, the uninstalled state information 71a to 71d corresponding to all the applications may be displayed as illustrated in FIG. 4.

The launcher application of the user terminal 1 may detect an installation instruction for the first application on the first application list (S25). Furthermore, in response to the detection of the installation instruction, the launcher application may request information on the first application from the server 3 (S27).

Next, the server 3 may extract information of the first application from a plurality of application information that is being stored and transmit the extracted information to the user terminal 1 (S29). The first application information may include the URL, the icon of the application, the package name of the application, and the splash screen.

Furthermore, the launcher application of the user terminal 1 may identify the URL from received information of the first application and store the URL corresponding to the first application, thereby installing the first application in the user terminal 1 (S31). In one embodiment, upon installing the first application, the launcher application may register the icon on the desktop or the home screen, and may also register the package name of the first application in the OS. In addition, in some embodiments, the package name of the first application may be registered in the OS of the user terminal in association with the launcher application such that the launcher application is executed when the executable instruction including the package name of the first application is detected in the OS of the user terminal 1. When the application has been installed, the application may be in an activated state.

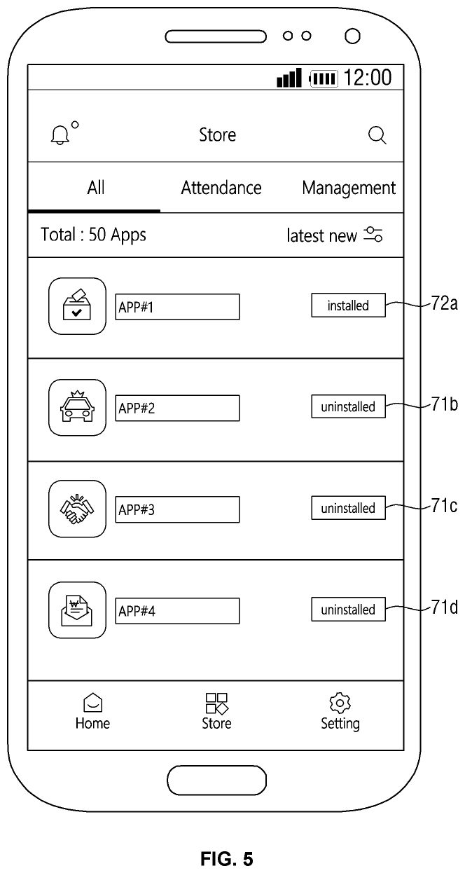

FIG. 5 is a view illustrating another example of a first application list displayed in a first GUI.

Upon comparing FIG. 4 with FIG. 5, when the first application has been installed, the launcher application may change the state information of the first application from “uninstalled 71a” to “installed 72a” in the first GUI.

Next, the launcher application may display the second GUI, but may display a second application list in the second GUI (S33). The second application may be a list of applications activated (i.e., installed) via the launcher application. In addition, an application icon list may be displayed on the second GUI as an application list.

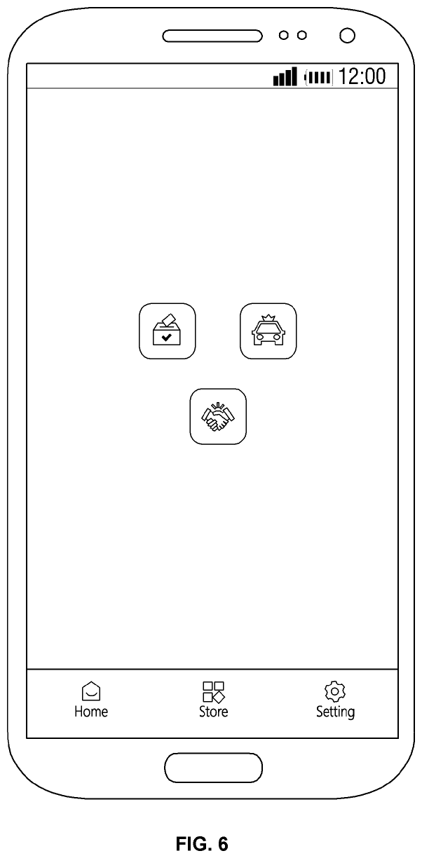

FIG. 6 is a view illustrating a second application list displayed in a second GUI, and as illustrated in FIG. 6, a plurality of icons may be displayed in the second GUI as the second application list. In some embodiments, the second application list including the application name instead of the icon may be displayed in the second GUI.

Furthermore, in the launcher application, the second application may be selected from the second application list by the user (S35). Next, the launcher application may execute the second application by identifying the URL of the selected second application, and accessing the URL to obtain and display an initial document (e.g., a web page). In one embodiment, the launcher application may request and obtain the URL of the second application from the server 3. In some embodiments, at the time of execution of the launcher application, information of a previously installed (i.e., activated) application may be received from the server 3, and in this case, the launcher application may identify the URL of the second application from the information of the second application that is being stored. A variety of links may be included in the document, and the user may obtain more detailed information by selecting the links included in the document.

According to the present embodiment, the application may be installed without downloading a separate binary executable file or installation file from the server 3. In addition, the application may be executed by accessing the URL without executing the binary executable of the application. Therefore, the installation speed of the application of the present disclosure may be improved, and the execution speed of the application may be improved.

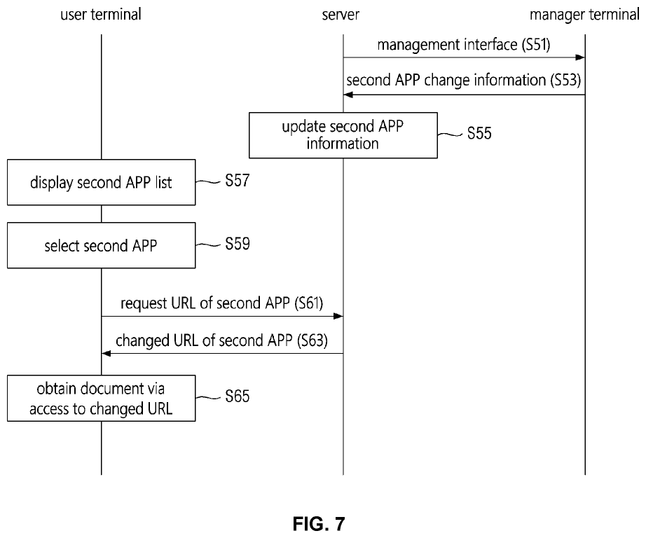

Hereinafter, when the URL of the second application is changed, a method for executing the second application will be described with reference to FIG. 7.

The manager terminal 2 may receive the management interface from the server 3 again to change the information of the second application (S51). Furthermore, the manager may change the URL of the second application using the management interface and transmit information of the second application of which the URL has been changed to the server 3 (S53).

Furthermore, the server 3 may update the existing second application information using the received second application information (S55). Accordingly, the URL of the second application changed by the manager may be reflected in the server 3.

In the state in which the URL of the second application is changed, the launcher application of the user terminal 1 may display the second GUI but may display the second application list in the second GUI (S57). Furthermore, in the launcher application, the second application may be selected from the second application list by the user (S59). Next, the launcher application may request the selected URL of the second application from the server 3 (S61) and receive the changed URL of the second application from the server 3 (S63). In some embodiments, at the time of the execution of the launcher application, the launcher application may receive the information of the second application of which the URL has been changed from the server 3, and in this case, the launcher application may identify the changed URL of the second application from the information of the second application that is already being stored.

Next, the launcher application may execute the second application by identifying the changed URL of the second application, and accessing the changed URL to obtain and display an initial document (e.g., a web page) (S65).

According to the present embodiment, even though the URL of the second application is changed, the URL of the second application changed at the time the execution of the second application is obtained without performing a separate update process in the user terminal 1, and the user terminal 1 may access the changed URL to normally execute the second application. Therefore, this can reduce the inconvenience during the application update process and save computing resources. In addition, since the manager can control access to the changed URL without a separate notification by simply registering URL change information of the second application, he/she may feel it is convenient in managing the application.

Meanwhile, the manager may change the icon in addition to the URL. In this case, the information on the second application including the changed icon is registered in the server 3, and at the time of the execution of the launcher application of the user terminal 1, the changed icon of the second application may be obtained from the server 1 and applied to the user terminal 1.

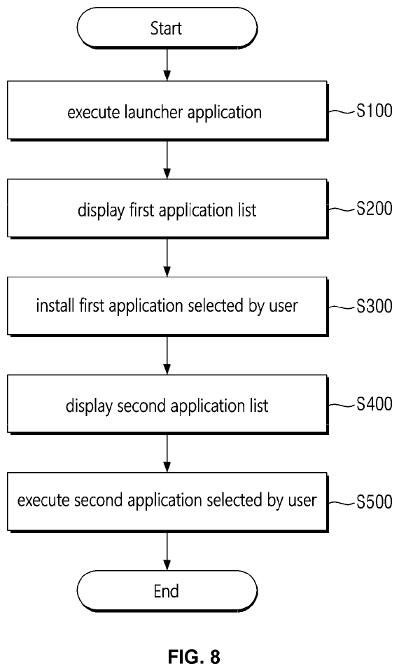

FIG. 8 is a flowchart of a method for managing an application according to another embodiment of the present disclosure.

Each step of the method illustrated in FIG. 8 may be performed by the computing device. In other words, each step of the method may be implemented with one or more instructions executed by the processor of the computing device. First steps included in the method may be performed by a first computing device, and second steps of the present method may be performed by a second computing device. Hereinafter, a further description will be continued assuming that each step of the present method is performed by the user terminal 1 described with reference to FIG. 1; however, the subject of performing each step is only an example, and the present disclosure is not limited to the following description. For the convenience of explanation, the description of the subject of performing some steps included in the method may be omitted herein.

Referring to FIG. 8, the user terminal 1 may execute the launcher application (S100). In one embodiment, when the API associated with the launcher application is called, the launcher application may be executed in the user terminal 1.

When the launcher application is executed in the user terminal 1, the launcher application may display the first GUI, but may display the first application list in the first GUI (S200). The first application list may be a full list of applications (entire application list) managed by the launcher application.

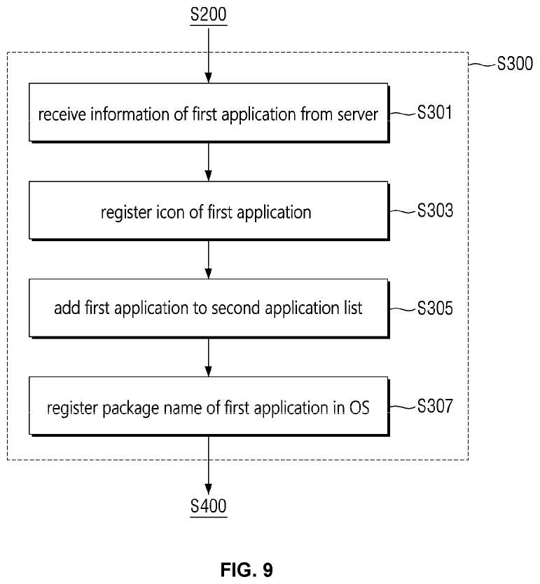

Furthermore, the launcher application of the user terminal 1 may detect the installation instruction of the first application selected by the user from the applications included on the first application list. In response to detecting the installation instruction of the first application, the launcher application may obtain the information of the first application from the server 3 and install the first application in the user terminal 1 using the obtained information of the application instead of downloading the binary executable file or the installation file of the application from the server 3 (S300). The first application information may include the URL, the icon of the application, the package name of the application, and the splash screen. The step S300 in FIG. 8 will be described in more detail with reference to FIG. 9.

Next, the launcher application of the user terminal 1 may display the second GUI, but may display the second application list in the second GUI (S400). In one embodiment, when an instruction for a second GUI output is received from a user, the second GUI may be displayed. The second application may be a list of applications activated (i.e., installed) via the launcher application. In addition, the application icon list may be displayed on the second GUI as the application list.

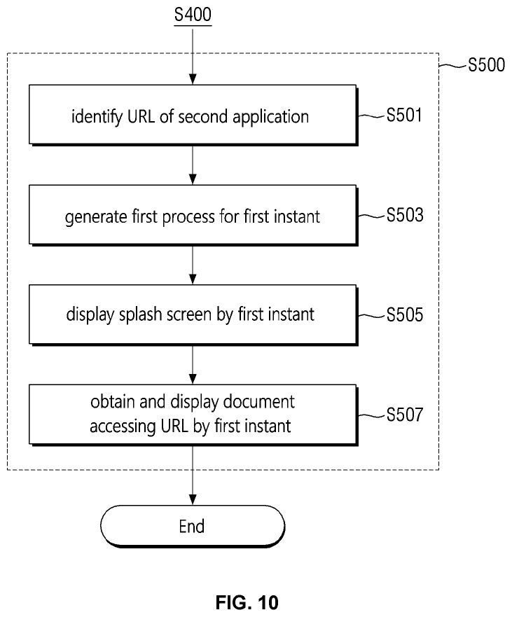

Furthermore, in the launcher application of the user terminal 1, the second application is selected from the second application list by the user, the URL corresponding to the selected application is identified. The launcher application may execute the second application by identifying the URL corresponding to the selected second application, and accessing the URL to obtain and display the document (e.g., a web page) (S500). The step S500 in FIG. 8 will be described in more detail with reference to FIG. 10.

Hereinafter, the step S300 in FIG. 8 will be described in detail with reference to FIG. 9.

The launcher application of the user terminal 1 may obtain the information of the first application requested to be installed from the server 3 (S301). That is, the user terminal 1 may obtain the information of the first application from the server 3 instead of downloading the binary executable file or the installation file of the application from the server 3. The first application information may include the URL of the first application, the icon of the first application, the package name of the first application, and the splash screen displaying loading the first application.

Furthermore, the launcher application of the user terminal 1 may identify and store the URL of the first application, and may also register the icon of the first application on the screen (e.g., a desktop or a home screen) of the user terminal 1 (S303). Next, the launcher application of the user terminal 1 may add the installed first application to the second application list (S305).

Next, the launcher application of the user terminal 1 may identify the package name of the first application from the first application information and may register the package name of the first application in the OS (S307). In addition, in some embodiments, the package name of the first application may be registered in the OS of the user terminal in association with the launcher application such that the launcher application is executed when the executable instruction including the package name of the first application is detected in the OS of the user terminal 1. In addition, the launcher application may change the state information of the first application displayed in the first application list. For example, the launcher application may change the state information of the first application from an “uninstalled” state to an “installed” state on the first application list.

According to the present embodiment, instead of downloading the binary executable file or the installation file of the application from the server 3, the first application may be installed via icon registration, package name registration and list management, thereby improving the installation speed of the first application and saving the resources (e.g., a storage space) required to install the first application.

Hereinafter, the step S500 in FIG. 8 will be described in detail with reference to FIG. 10.

When detecting the executable instruction for the second application included on the second application list, the launcher application of the user terminal 1 may identify the URL corresponding to the second application (S501). In one embodiment, when detecting the execution of the second application, the launcher application of the user terminal 1 may request the URL of the second application from the server 3 and receive the URL of the second application from the server 3. In some embodiments, the launcher application may receive and obtain the URL of the second application from the server 3 in advance at the time of the execution of the launcher application.

Next, the user terminal 1 may generate a first instance of the launcher application, generate a first process for the first instance, and then allocate the first instance to the second application for the execution of the second application (S503). That is, the first instance of the launcher application with an individual process for processing the second application may be generated and allocated for the second application.

Furthermore, the first instance of the launcher application may obtain the splash screen from the second application information and then display the obtained splash screen (S505). That is, the first instance may display the splash screen corresponding to the second application, and accordingly, the user may recognize that the second application is being loaded.

Furthermore, the first instance may access the URL corresponding to the second application to obtain the document and display the obtained document (S507). When the obtained document is displayed, the splash screen corresponding to the second application may be removed from the screen.

According to the present embodiment, instead of executing the binary executable file of the second application on the user terminal, the launcher application may execute the second application by accessing the URL corresponding to the second application, and obtaining and displaying the document.

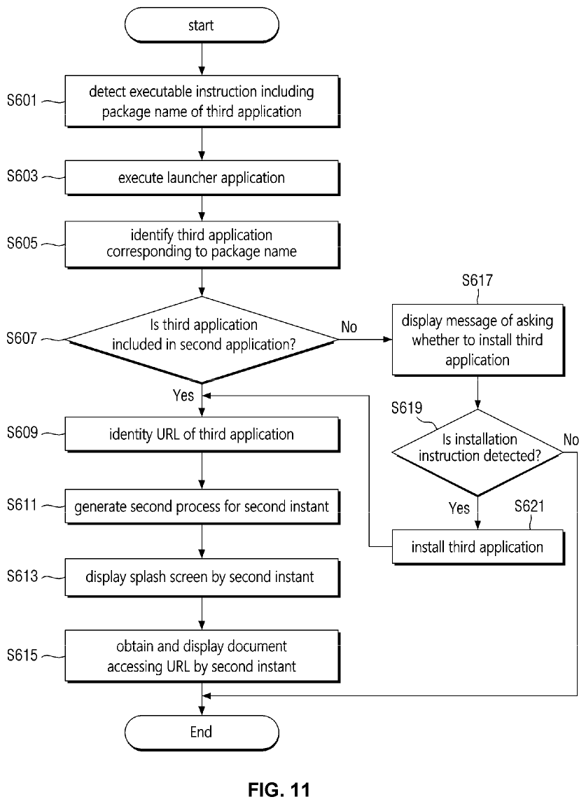

Hereinafter, a method for operating an additional third application will be described with reference to FIG. 11.

Each step of the method illustrated in FIG. 11 may be performed by the computing device. In other words, each step of the method may be implemented with one or more instructions executed by the processor of the computing device. The first steps included in the method may be performed by the first computing device, and the second steps of the present method may be performed by the second computing device. Hereinafter, a further description will be continued assuming that each step of the present method is performed by the user terminal 1 described with reference to FIG. 1; however, the subject of performing each step is only an example, and the present disclosure is not limited to the following description. For the convenience of explanation, the description of the subject of performing some steps included in the method may be omitted herein.

Referring to FIG. 11, the user terminal 1 may detect the executable instruction including the package name of the third application (S601). In one embodiment, when the user directly inputs the package name in an instruction input window, the executable instruction may be detected. In some embodiments, the executable instruction may be detected when the icon corresponding to the third application is selected. In some embodiments, the executable instruction may be detected when the link including the package name of the third application is selected by the user.

Furthermore, the user terminal 1 may execute the launcher application (S603). In some embodiments, when the launcher application is executed, the URLs of each of the applications included on the second application list may be obtained from the server 3 and stored. Next, the launcher application of the user terminal 1 may identify the third application corresponding to the package name among the plurality of applications in the launcher application (S605).

Next, the launcher application may determine whether the identified third application is included on the second application list (S607). That is, the launcher application may determine whether the third application is an installed application by determining whether the third application is included on the second application list.

The launcher application may identify the URL corresponding to the third application in response to determining that the third application is included on the second application list (S609). In one embodiment, when the third application is determined to be included on the second application list, the launcher application may identify the URL by requesting and receiving the URL corresponding to the third application from the server 3. In some embodiments, the launcher application may obtain and store the URLs of each of the applications included on the second application list during the execution of the launcher application, and may identify the URL corresponding to the third application from the URLs for each of the stored applications.

Next, the launcher application may generate a second instance, generate a second process for the second instance, and then allocate the second instance to the third application for execution of the third application (S611). That is, the second instance of the launcher application with an individual process for the third application may be generated and allocated for the third application.

Furthermore, the second instance of the launcher application may obtain the splash screen corresponding to the third application and then display the obtained splash screen (S613). That is, the second instance may display the splash screen corresponding to the third application, and accordingly, the user may recognize that the third application is being loaded.

Next, the second instance may access the URL corresponding to the third application to obtain the document and display the obtained document (S615). When the obtained document is displayed, the splash screen corresponding to the third application may be removed from the screen.

Meanwhile, in the step S607, the launcher application may display a message of asking whether to install the third application in response to determining that the third application is not included on the second application list (S617).

Next, the launcher application may obtain the information of the third application from the server 3 in response to the determination that the installation instruction of the third application is detected (S619), and install the third application using the obtained information of the third application (S619). In one embodiment, the icon of the third application may be registered on the screen, and the package name of the third application may be registered in the OS of the user terminal 1. In addition, the launcher application may add the third application to the second application list, and may also change the state information of the third application on the first application list. Furthermore, as the step S609 advances, the third application may be executed.

According to the present embodiment, a separate instance is allocated to each of the applications under execution, and each of the applications is operated via the individual process allocated to the instance.

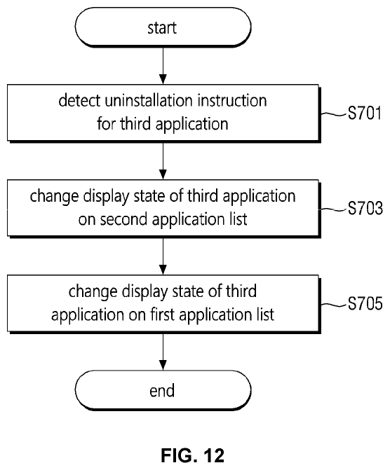

Hereinafter, a method for uninstalling the application in the launcher application will be described with reference to FIG. 12.

The launcher application of the user terminal 1 may detect an uninstallation instruction of the previously installed third application (S701).

The launcher application of the user terminal 1 may change a display state of the third application on the second application list displayed in the second GUI instead of deleting the binary executable file of the third application from the user terminal 1 in response to the detection of the uninstallation instruction (S703). In one embodiment, the user terminal 1 may remove the third application from the second application list. For example, referring to FIG. 6, the launcher application may remove the icon corresponding to the third application from the second application list (i.e., an icon list) displayed in the second GUI.

Next, the launcher application may change the display state of the third application on the first application list displayed in the first GUI (S705). In one embodiment, the launcher application may change from a display state indicative of the third application being installed on the first application list to a display state indicative of the third application being uninstalled, on the first application list displayed in the first GUI.

For example, referring to FIG. 6, the launcher application may change the state information 71c corresponding to the third application from a display state (for example, installed) indicative of the completed installation of the third application to a display state (for example, uninstalled) indicative of the uninstallation thereof.

According to the present embodiment, when the application is removed, since only the display state is changed without removing the binary executable file, the computing resources upon the uninstallation of the application may be saved and the uninstallation speed may be improved.

Hereinafter, a hardware configuration of an exemplary computing device according to some embodiments will be described with reference to FIG. 9.

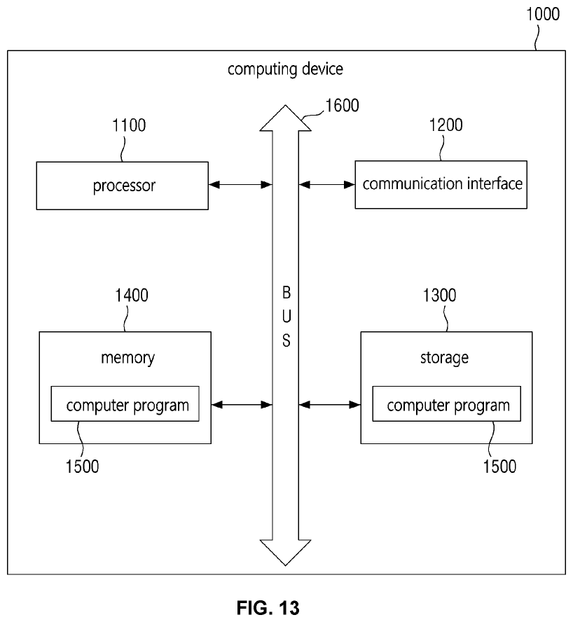

FIG. 13 is a view illustrating an exemplary hardware configuration for implementing a computing device according to various embodiments. A computing device 1000 according to the present embodiment may include one or more processors 1100, a system bus 1600, a network interface 1200, a memory 1400 configured to load a computer program 1500 performed by the processor 1100, and a storage 1300 configured to store the computer program 1500. FIG. 13 illustrates only components related to the embodiment. Therefore, it may be found by a person skilled in the technical file to which the embodiments of the present specification belong that other universal components may be further included in addition to the components illustrated in FIG. 13.

The processor 1100 may control overall operations of each component of the computing device 1000. The processor 1100 may include at least one of a central processing unit (CPU), a micro-processor unit (MPU), a micro-controller unit (MCU), a graphical processing unit (GPU), or any type of processor known in the technical field of the present disclosure. In addition, the processor 1100 may perform an arithmetic operation on at least one application or program for the purpose of executing the method/operation according to various embodiments. The computing device 1000 may include two or more processors.

The memory 1400 stores different kinds of data, instructions, and/or information. The memory 1400 may load one or more computer programs 1500 from the storage 1300 to execute methods/operations according to various embodiments of the present disclosure. An example of the memory 1400 may be RAM, but the present invention is not limited thereto. The system bus 1600 provides a communication function between the components of the computing device 1000.

The bus may be implemented as various types of buses such as an address bus, a data bus, and a control bus. The network interface 1200 may be connected to a communication network. The storage 1300 may non-temporarily store the one or more computer programs 1500. The storage 1300 may include a non-volatile memory such as a flash memory, a hard disk, a removable disk, or any type of computer-readable recording medium known in the technical field to which embodiments of the present disclosure belong.

The computer program 1500 may include one or more instructions in which the methods/operations according to various embodiments of the present disclosure are implemented. When the computer program 1500 is loaded into the memory 1400, the processor 1100 may perform the methods/operations according to various embodiments of the present disclosure by executing the one or more instructions. The computer program 1500 may include the instructions for the method described with reference to FIGS. 2 to 12.

In one embodiment, the computer program 1500 may include instructions that cause the processor to perform an operation of executing the launcher application on the user terminal 1, an operation of displaying the first application list within the first GUI of the launcher application, an operation of installing the first application selected by the user from applications included on the first application list in the user terminal 1, an operation of displaying the second application list within the second GUI of the launcher application, and an operation of executing the second application selected by the user from the applications included on the second application list.

In one embodiment, the operation of installing the first application on the user terminal 1 may include an operation of identifying the URL corresponding to the first application instead of downloading the binary executable file or the installation file of the first application from the server 3.

In one embodiment, the operation of executing the second application may include an operation of accessing the URL corresponding to the second application by the launch application instead of executing the binary executable file of the second application on the user terminal 1, and the URL corresponding to the second application may be previously stored in the user terminal 1.

So far, a variety of embodiments of the present disclosure and the effects according to embodiments thereof have been mentioned with reference to FIGS. 1 to 13. The effects according to the technical idea of the present disclosure are not limited to the forementioned effects, and other unmentioned effects may be clearly understood by those skilled in the art from the following description.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for managing an application executed in a user terminal, the method comprising:
executing a launcher application having a first graphical user interface (GUI) and a second graphical user interface (GUI) on the user terminal;
displaying a first application list comprising applications within the first GUI of the launcher application;
installing, in the user terminal, a first application selected by a user from the applications included on the first application list;
displaying a second application list comprising applications within the second GUI of the launcher application; and
executing a second application selected by the user from the applications included on the second application list,
wherein the installing comprises identifying a first uniform resource locator (URL) corresponding to the first application without downloading a binary executable file of the first application or an installation file of the first application from a server, and
the executing of the second application comprises accessing a second uniform resource locator (URL) corresponding to the second application by the launcher application without executing a binary executable file of the second application on the user terminal,
wherein the second URL is previously stored in the user terminal.

2. The method of claim 1, wherein the installing of the first application in the user terminal comprises:
adding the first application to the second application list.

3. The method of claim 1, wherein the installing of the first application in the user terminal comprises:
registering a package name corresponding to the first application in an operating system (OS) of the user terminal.

4. The method of claim 1, wherein the executing of the second application further comprises:
prior to displaying a document obtained from the second URL on the user terminal, displaying a splash screen corresponding to the second application by the launcher application,
wherein the splash screen is previously stored in the user terminal.

5. The method of claim 1, further comprising:
detecting an executable instruction including an application package name on the user terminal;
in response to detecting the executable instruction, executing the launcher application; and
executing a third application by the launcher application, based on determining, by the launcher application, that the third application corresponding to the package name is included on the second application list.

6. The method of claim 5, further comprising:
displaying a message of asking whether to install the third application by the launch application, based on determining, by the launcher application, that the third application corresponding to the package name is not included on the second application list.

7. The method of claim 1, wherein the executing of the second application further comprises accessing the second URL by a first instance of the launcher application; and
the method further comprises:
after the executing of the second application, detecting an executable instruction for a third application included on the second application list on the user terminal;
generating a new process for a second instance of the launcher application on the user terminal; and
executing the third application by the second instance of the launcher application on the user terminal.

8. The method of claim 1, further comprising updating the second URL by the server,
wherein the executing of the launcher application comprises obtaining the updated second URL from the server.

9. The method of claim 8, wherein the updating of the second URL comprises:
providing a manager terminal with a management interface configured for changing information on the second application; and
obtaining the updated second URL from the manager terminal.

10. The method of claim 1, further comprising:
obtaining an uninstallation instruction for a third application among the applications included on the second application list; and
in response to the uninstallation instruction, changing a display state of the third application on the second application list displayed in the second GUI without deleting the binary executable file of the third application from the user terminal.

11. The method of claim 10, further comprising:
in response to the uninstallation instruction, changing the display state of the third application on the first application list displayed within the first GUI.

12. A computing device comprising:
one or more processors;
a memory configured to load a program executed by the processors; and
a storage having the program stored therein,
wherein the program comprises instructions that cause the one or more processors to perform operations comprising:
executing a launcher application having a first graphical user interface (GUI) and a second graphical user interface (GUI) on a user terminal;
displaying a first application list comprising applications within the first GUI of the launcher application;
installing a first application selected by a user from the applications included on the first application list in the user terminal; and
displaying a second application list comprising applications within the second GUI of the launcher application;
executing a second application selected by the user from the applications included on the second application list,
wherein the installing of a first application in the user terminal comprises an operation of identifying a first uniform resource locator (URL) corresponding to the first application without downloading a binary executable file of the first application or an installation file of the first application from a server; and
the executing of the second application comprises an operation of accessing a second uniform resource locator (URL) corresponding to the second application by the launcher application without executing a binary executable file of the second application on the user terminal,
wherein the second URL is previously stored in the user terminal.

13. The computing device according to claim 12, wherein the installing of the first application comprises an operation of adding the first application to the second application list.

14. The computing device according to claim 12, wherein the operations further comprise:
detecting an executable instruction including an application package name on the user terminal;
in response to detecting the executable instruction, executing the launcher application; and
executing a third application by the launcher application, based on determining, by the launcher application, that the third application corresponding to the package name is included on the second application list.

15. The computing device according to claim 14, wherein the operations further comprise:
displaying a message of asking whether to install the third application by the launch application, based on determining, by the launcher application, that the third application corresponding to the package name is not included on the second application list.

16. The computing device according to claim 12, wherein the executing of the second application further comprises an operation of accessing the second URL by a first instance of the launcher application; and
the operations further comprises:
after the executing of the second application, detecting an executable instruction for a third application included on the second application list on the user terminal;
generating a new process for a second instance of the launcher application on the user terminal; and
executing the third application by the second instance of the launcher application on the user terminal.

17. The computing device according to claim 12, wherein the operations further comprise:
updating the second URL by the server,
wherein the executing of the second application comprises an operation of obtaining the updated second URL from the server.

18. The computing device according to claim 17, wherein the updating of the second URL comprises:
an operation of providing a manager terminal with a management interface configured for changing information on the second application; and
an operation of obtaining the updated second URL from the manager terminal.

19. The computing device according to claim 12, wherein the operations further comprise:
an operation of obtaining an uninstallation instruction for a third application among the applications included on the second application list; and
an operation of, in response to the uninstallation instruction, changing a display state of the third application on the second application list displayed in the second GUI without deleting the binary executable file of the third application from the user terminal.

20. The computing device according to claim 12, wherein the operations further comprise:
an operation of, in response to the uninstallation instruction, changing the display state of the third application on the first application list displayed within the first GUI.
